(19) United States
(12) Patent Application Publication
(10) Pub. No.: US 2008/0231540 A1
(43) Pub. Date: Sep. 25, 2008

(54) Gaussian radiative cluster

(76) Inventor: Art Unwin, Bloomington, IL (US)

Correspondence Address: ART UNWIN, 15394 OLD COLONIAL RD, BLOOMINGTON, IL, 61704, US

(21) Appl. No.: 11/655,899

(22) Filed: Mar. 16, 2007

(51) Int. Cl. H01Q 21/00

(52) U.S. Cl. 343/893

(57) ABSTRACT

A resonant radiating array comprising of a cluster of randomly arranged resonant elements for producing a radiation field

### BACKGROUND OF THE INVENTION

1. Field of Invention

This invention relates to a radio frequency radiator using randomly clustered resonant radiating elements where such arrays diminish the compromises that must be made in the design of existing arrays.

2. Discussion of the Related Technology

The Yagi-Uda array has been the most popular antenna of use for nearly 100 years first as a means for sky wave communication and lately also for line of sight communication. With the latter has come a need for frequencies in band form which is providing difficulties to designers. The Yagi antenna has a plethora of detuned elements compared to the driven element which is always resonant. The detuned elements which are also known as parasitic elements have impedances that are of capacitive or inductive nature with respect to the arrays designed frequency of use. The capacitive and conductive elements in the design contributes to unwanted compromises in desired features required of the array especially when the array is used for a band of frequencies. (see ARRL Antenna Handbook Edition 17, chapter 11)

### SUMMARY OF INVENTION

The new invention is designed around a cluster of resonant radiating elements that are of a random placement and where each of these radiating elements are resonant at the design frequency as the clustered elements are as a whole. Such a clustered array has less reactive components in the impedance of each element within the cluster and minimizes compromises that must be made in the design of a radiation array for a band of frequencies.

### BRIEF DESCRIPTION OF THE DRAWINGS

FIG. 1A. shows a Gaussian field

FIG. 1B. shows a Conservative field

FIG. 2. shows a three element radiative cluster array

FIG. 3A. shows dimensions of said three element array

FIG. 3B shows computer derived radiative performance of said array

### DETAILED DESCRIPTION OF THE PREFERRED EMBODIMENTS

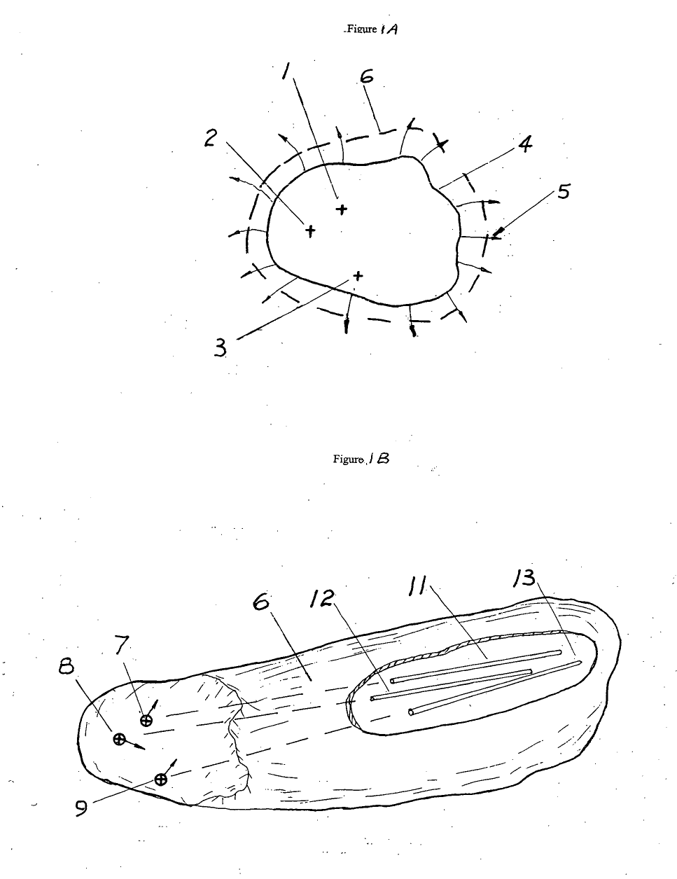

FIG. 1. shows how a Gaussian array where charges in equilibrium 1 thru 3 are bound in the volume 4 and where the flux 5 is shown emminating thru the arbitary border 6 The above drawing is a basic Gaussian field for static charges where Gausses law states that the total electric flux out of the arbitary closed surface in free space is proportional to the net electric discharge within the surface.

It is extremely important to note that a measure of time is absent from the above law.

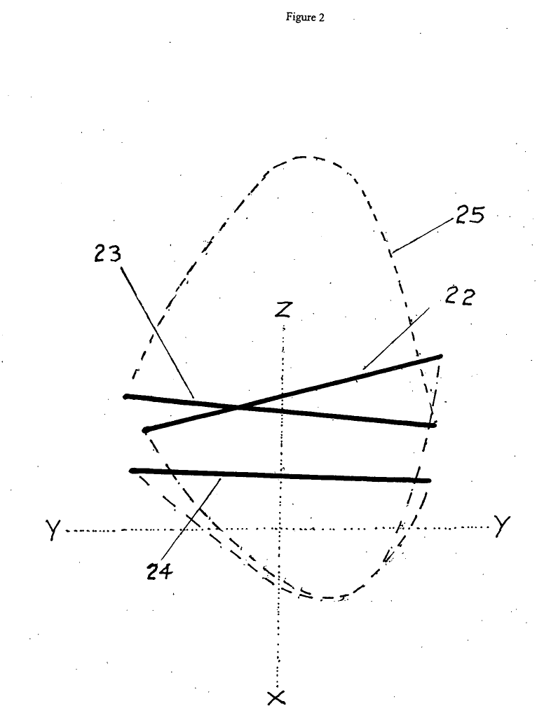

FIG. 2. shows a Conservative field which can be seen as a Gaussian field where the charges 7 thru 9 are shown on the surface of the closed volume 6 and are the charges 1 thru 3 that were on the surface of each element 11 thru 13 when a time varying field was applied to the internal clustered array for a short period of time during which a current of a given phase was imposed on each element 11 thru 13, the vector on the charges 7 thru 9 represent the current phase angle where the vector value is zero. At the same time the array is to be seen as in equilibrium as the direction of current flow in all elements change at the same time. When a time varying field is applied to the internal array the addition of curl represented by the vector of value can be seen as a transition to electromechanical law from the Gaussian law for statics when the term of time is added to the Gaussian Statics Law.

The clustered radiating array uses three dimensional Cartesian coordinates where all elements 11 thru 13 can be randomly placed as long as all near resonant requirements are maintained which signifies equilibrium for the cluster. When construction limits are imposed on the array design it may be necessary to add a detuned element to the array which by virtue of its detuned nature provides a current flow that is out of sync with other elements thus creating a relative weakness in the arbitary boundary which affects the shape of the radiation field. When a detuned element is added all other elements 13 thru 15 must be re-adjusted for individual resonance as must the radiating array in its entirety.

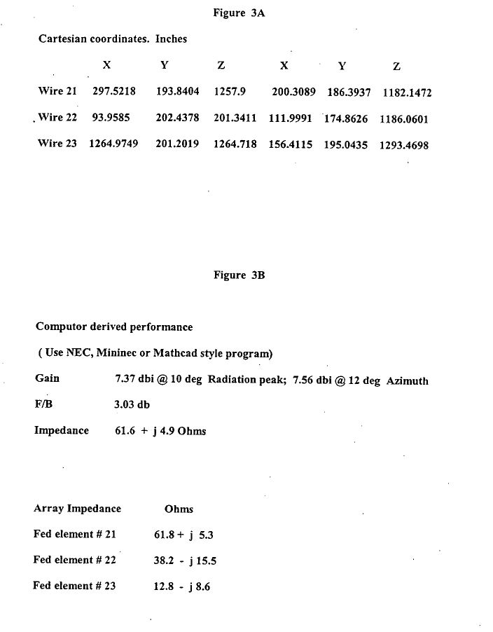

FIG. 3. shows a three dimensional Cartesian layout of a representative three element radiative Gaussian cluster where the elements 22 thru 24 are made of aluminum rods of one inch diameter. The lengths of the elements are dissimilar as is their placement. Imposed on the elements 22 thru 24 are the current and phase 25 of the time relative imposed when the array is fed

FIG. 4A shows the dimensions of the array in a three dimensional Cartesian form which illustrates a random arrangement where a particular performance feature was not pursued

FIG. 4B. shows the output performance data of the above array together with each elements impedance when used as the feed element where it can be seen that the reactive values are minimal for each element. which allows for radiation performance curves to be in sync with each other as movement across the frequency band is enabled. An important feature of this is that the gain curve is of a band pass filter type where the gain is relatively constant as frequency is changed. A further advantage of using elements that are resonant versus other arrays is that with the elements being of a constant “Q” use can now be made of complex circuitry methods for array design which is so much quicker than other methods. Another advantage of using resonant elements is that the total array requires a turning radius which is much less than existing designs with an according less torque requirement of the rotor system.

I claim:

1. A array of two or more radiating elements arranged in a cluster form without being on a common plane and within a arbitrary boundary where each element is resonant at the designed frequency of use and where the cluster in its entirety is also resonant at the arrays designed frequency of use.

2. A clustered array according to claim 1 where one or more detuned forms of elements are added to the said cluster while maintaining the resonance properties of the said cluster and other elements within said cluster.

3. A clustered array according to claim 1 where the radiating elements of said cluster have random three dimensional Cartesian directional positions of placement with respect to each other and the surface of the earth.

4. A clustered array according to claim 1 where another clustered arrangement of radiating elements are positioned to form a mutual coupling between said clusters.

5. A clustered array of elements according to claim 1 where additional radiating elements of a detuned nature relative to the arrays frequency of use are placed outside and around the radiative cluster.

6. A clustered array of radiating elements according to claim 1 where the radiating elements are positioned on or near a solid dielectric.
The scope of the invention is indicated in the appended claims which supersede Yagi technology. I intend that all changes or modifications within the meaning and range of equivalents are embraced by the claims.
